(19) United States
(12) Patent Application Publication
(10) Pub. No.: US 2016/0227142 A1
(43) Pub. Date: Aug. 4, 2016

(54) FINGERPRINT SENSOR AND SENSING METHOD THEREOF

(71) Applicant: Egis Technology Inc., Taipei (TW)

(72) Inventor: Todd LIN, Taipei (TW)

(21) Appl. No.: 14/791,154

(22) Filed: Jul. 2, 2015

(30) Foreign Application Priority Data
Feb. 2, 2015 (CN) 201510053091.X

(51) Int. Cl. H04N 5/378; H04N 5/369; G06K 9/00

(52) U.S. Cl. CPC H04N 5/378; G06K 9/00013; H04N 5/369

(57) ABSTRACT

A fingerprint sensor is provided for sensing fingerprint information of a finger. The fingerprint sensor includes a sensing array, a readout module and a processor. The sensing array includes a plurality of sensing units. Each of the sensing units includes a sensing electrode. The readout module provides a sensing output according to a first sensing voltage from the sensing array and an average voltage of a plurality of second sensing voltages from the sensing array. The processor generates the fingerprint information of the finger according to the sensing output. The first sensing voltage is provided by the sensing electrode of a first sensing unit of the sensing units, and each of the second sensing voltage is provided by the sensing electrode of a second sensing unit of the sensing units. The second sensing units are neighboring to the first sensing unit.

### CROSS REFERENCE TO RELATED APPLICATIONS

This Application claims priority of China Patent Application No. 201510053091.X, filed on Feb. 2, 2015, the entirety of which is incorporated by reference herein.

### BACKGROUND OF THE INVENTION

1. Field of the Invention

The invention relates to a fingerprint sensor, and more particularly, to a fingerprint sensor capable of removing common mode noise.

2. Description of the Related Art

In recent years, biological identification technology has become increasingly mature, and different biological features can be used for identifying users. Since the recognition rate and accuracy of fingerprint identification technology are better than those of other biological feature identification technologies, fingerprint identification and verification are used extensively in various areas.

Fingerprint identification and verification technology detects a user's fingerprint image, captures fingerprint data from the fingerprint image, and saves the fingerprint data as a template. Thereafter, the user presses or slides the finger on or over the fingerprint sensor such that a fingerprint is captured and compared with a template. If the two match, then the user's identity is verified.

### BRIEF SUMMARY OF THE INVENTION

A fingerprint sensor and a sensing method thereof are provided. An embodiment of a fingerprint sensor is provided for sensing fingerprint information of a finger. The fingerprint sensor includes a sensing array, a readout module and a processor. The sensing array includes a plurality of sensing units. Each of the sensing units includes a sensing electrode. The readout module provides a sensing output according to a first sensing voltage from the sensing array and an average voltage of a plurality of second sensing voltages from the sensing array. The processor generates the fingerprint information of the finger according to the sensing output. The first sensing voltage is provided by the sensing electrode of a first sensing unit of the sensing units, and each of the second sensing voltage is provided by the sensing electrode of a second sensing unit of the sensing units. The second sensing units are neighboring to the first sensing unit.

Furthermore, an embodiment of a sensing method for a fingerprint sensor, wherein the fingerprint sensor comprises a sensing array having a plurality of sensing units disposed in a plurality of row lines and a plurality of column lines. A first sensing voltage of a first sensing unit of the sensing units is read. A plurality of second sensing voltages of a plurality of second sensing units of the sensing units are read. A sensing output is generated according to the first sensing voltage and an average voltage of the second sensing voltages, by a differential amplifier. Fingerprint information of a finger is generated according to the sensing output.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a fingerprint sensor according to an embodiment of the invention;

FIG. 2 shows a schematic diagram illustrating that the fingerprint sensor of FIG. 1 is used to obtain the fingerprint of the user;

FIG. 3 shows a sectional schematic illustrating the finger of the user contacting the fingerprint sensor of FIG. 1;

FIG. 4 shows a fingerprint sensor according to another embodiment of the invention;

FIG. 5 shows a sensing array for illustrating the relation among a target sensing unit and a plurality of reference sensing units according to an embodiment of the invention;

FIG. 6 shows a sensing array for illustrating the relation among a target sensing unit and a plurality of reference sensing units according to another embodiment of the invention;

FIG. 7 shows a sensing array for illustrating the relation among a target sensing unit and a plurality of reference sensing units according to another embodiment of the invention; and

FIG. 8 shows a sensing method for a fingerprint sensor according to an embodiment of the invention, wherein the fingerprint sensor comprises a sensing array having a plurality of sensing units, a readout module and a processor.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

When a user presses or slides his or her finger on or over a fingerprint sensor, the fingerprint sensor will sense the ridges and the valleys of the fingerprint, and generate different capacitance values corresponding to the ridges and valleys. Next, voltage values corresponding to the capacitance values are obtained by using a charge-sharing technique, and the voltage value is converted into a digital code. The digital code is provided to a processor for subsequent operation and fingerprint identification.

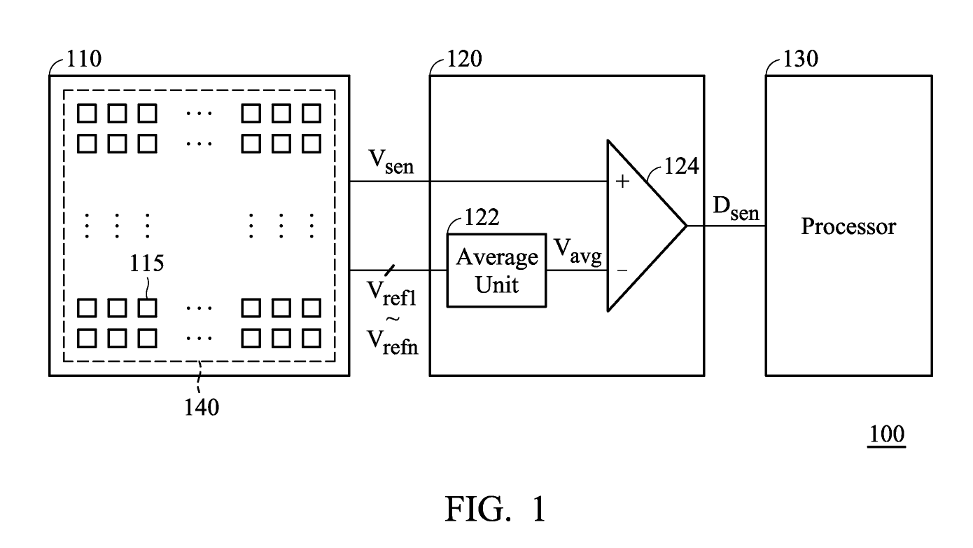

FIG. 1 shows a fingerprint sensor 100 according to an embodiment of the invention. The fingerprint sensor 100 comprises a sensing array 110, a readout module 120, a processor 130 and an insulating surface 140. The sensing array 110 is formed by a plurality of sensing units 115 arranged in a two-dimensional manner, wherein the insulating surface 140 overlays all of the sensing units 115 of the sensing array 110. The readout module 120 obtains a target sensing voltage Vₛₑₙ and a plurality of reference sensing voltages V_{ref1}-V_{refn} from the sensing array 110, wherein the target sensing voltage Vₛₑₙ is provided by a target sensing unit 115S which is going to sense in the sensing array 110, and the reference sensing voltages V_{ref1}-V_{refn} are respectively provided by a plurality of sensing units 115R neighboring to the target sensing unit 115S in the sensing array 110. The readout module 120 comprises an average unit 122 and a differential amplifier 124. The average unit 122 is used to average the reference sensing voltages V_{ref1}-V_{refn}, to provide a reference average voltage V_{avg}. Next, the differential amplifier 124 provides a sensing output Dₛₑₙ corresponding to the target sensing unit 115S to the processor 130 according to the target sensing voltage Vₛₑₙ and the reference average voltage V_{avg}. After obtaining the sensing output Dₛₑₙ of the target sensing unit 115S, the processor 130 determines whether the user's finger is in contact with the insulating surface 140, and further obtains fingerprint information of the finger, so as to determine that the sensing output Dₛₑₙ corresponds to a fingerprint ridge or a fingerprint valley of the finger. Thus, according to the sensing outputs Dₛₑₙ of all sensing units 115, the processor 130 obtains the binary or gray-level fingerprint data for subsequent processes, for example, a fingerprint identification operation is performed by a fingerprint identification algorithm.

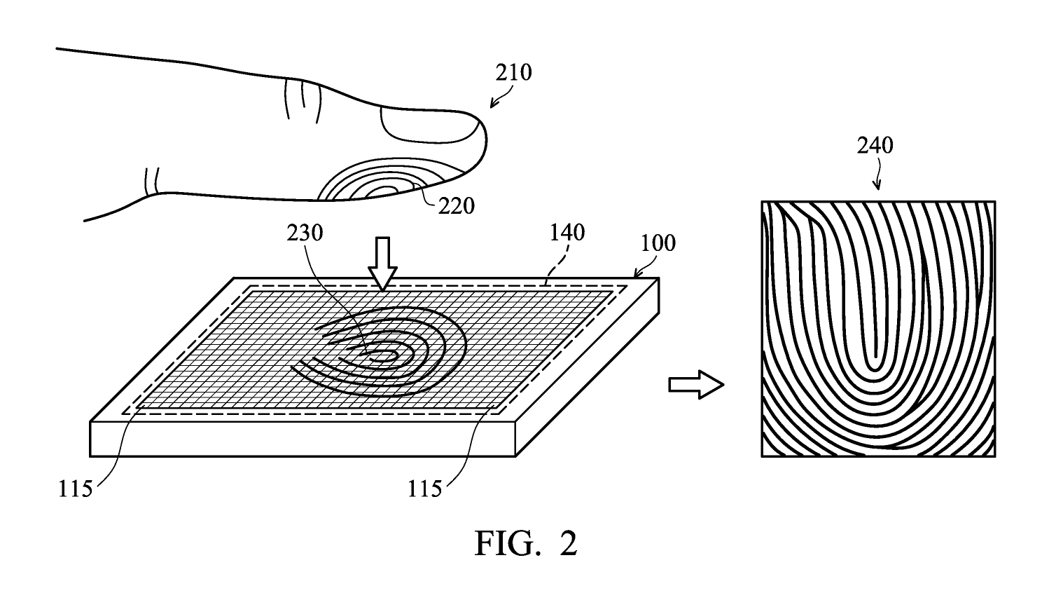

FIG. 2 shows a schematic diagram illustrating that the fingerprint sensor 100 of FIG. 1 is used to obtain the fingerprint of the user. In FIG. 2, when the finger 210 contacts the fingerprint sensor 100, the fingerprint ridges 220 on the surface of the finger 210 will contact and press the sensing units 115 via the insulating surface 140. Thus, the fingerprint sensor 100 obtains a capacitance curve 230 corresponding to the fingerprint ridges 220, and identifies the shape of the fingerprint ridges 220 according to the shape of the capacitance curve 230, so as to obtain a fingerprint pattern 240. Next, the other circuits or devices can perform subsequent processes according to the fingerprint pattern 240.

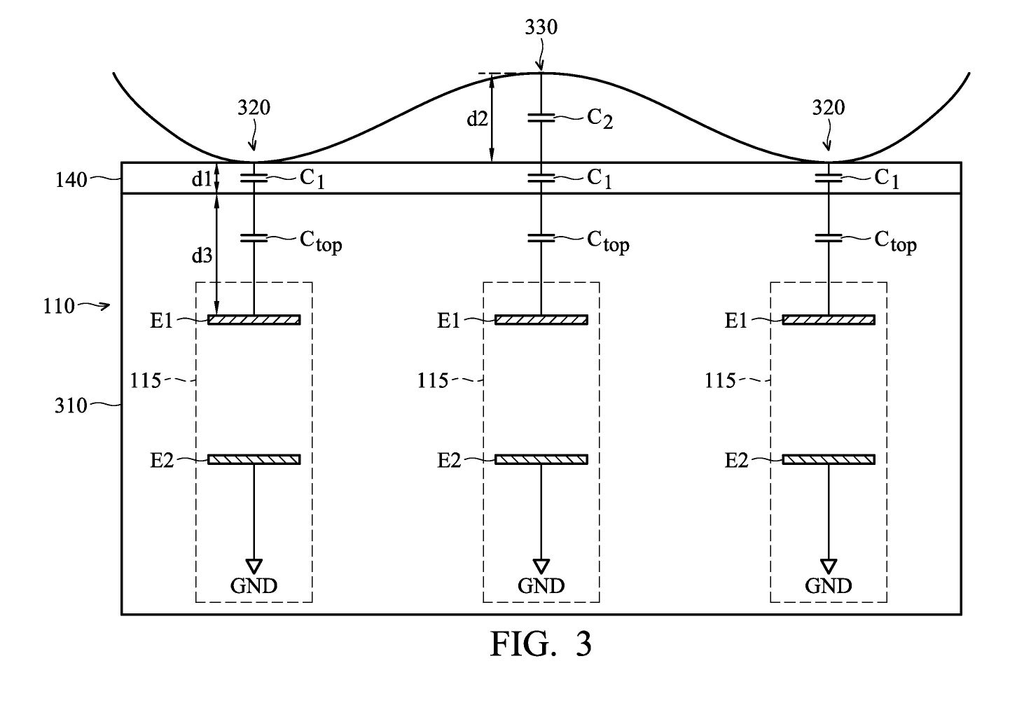

FIG. 3 shows a sectional schematic illustrating the finger of the user contacting the fingerprint sensor 100 of FIG. 1. In FIG. 3, the insulating surface 140 is disposed on the semiconductor substrate 310. In general, the insulating surface 140 is a protective dielectric layer formed by performing the integrated circuit manufacturing process. The thickness of the insulating surface 140 is d1, wherein an equivalent capacitor C₁ of the insulating surface 140 is determined by the thickness d1. Label 320 represents a fingerprint ridge of the finger, wherein the fingerprint ridge 320 of the finger will directly contact the insulating surface 140. Moreover, Label 330 represents a fingerprint valley of the finger, wherein a distance between the fingerprint valley 330 of finger and the insulating surface 140 is d2, and a capacitor C₂ between the fingerprint valley 330 and insulating surface 140 is determined by the distance d2. As described above, the sensing array 110 is formed by a plurality of sensing units 115. Each sensing unit 115 comprises the electrodes E1 and E2, wherein the electrodes E1 and E2 are formed by different metal layers within the semiconductor substrate 310. The electrode E1 is formed by a top metal layer and is disposed below the insulating surface 140, and the thickness of an insulation layer between the insulating surface 140 and the electrode E1 is d3, wherein an equivalent capacitor Cₜₒₚ on the insulation layer is determined according to the thickness d3. Therefore, when the fingerprint ridge 320 contacts the insulating surface 140, a sensing capacitor Cₛₑₙ between the fingerprint ridge 320 and the electrode E1 is formed by the capacitor Cₜₒₚ and the capacitor C₁ connected in series. Furthermore, comparing with the sensing capacitor Cₛₑₙ of the fingerprint ridge 320, a sensing capacitor Cₛₑₙ between the fingerprint valley 330 and the electrode E1 is formed by the capacitor Cₜₒₚ, the capacitor C₁ and the capacitor C₂ connected in series. Thus, when the finger contacts the insulating surface 140, the fingerprint ridge 320 and the fingerprint valley 330 will cause different capacitances, wherein the sensing capacitor Cₛₑₙ corresponding to the fingerprint valley 330 is smaller than the sensing capacitor Cₛₑₙ corresponding to the fingerprint ridge 320. Therefore, the readout module 120 of FIG. 1 can obtain the sensing voltage Vₛₑₙ corresponding to the sensing capacitor Cₛₑₙ via the electrode E1 of the sensing unit. Moreover, the electrode E2 is disposed below the electrode E1, wherein the electrode E2 is coupled to a ground GND.

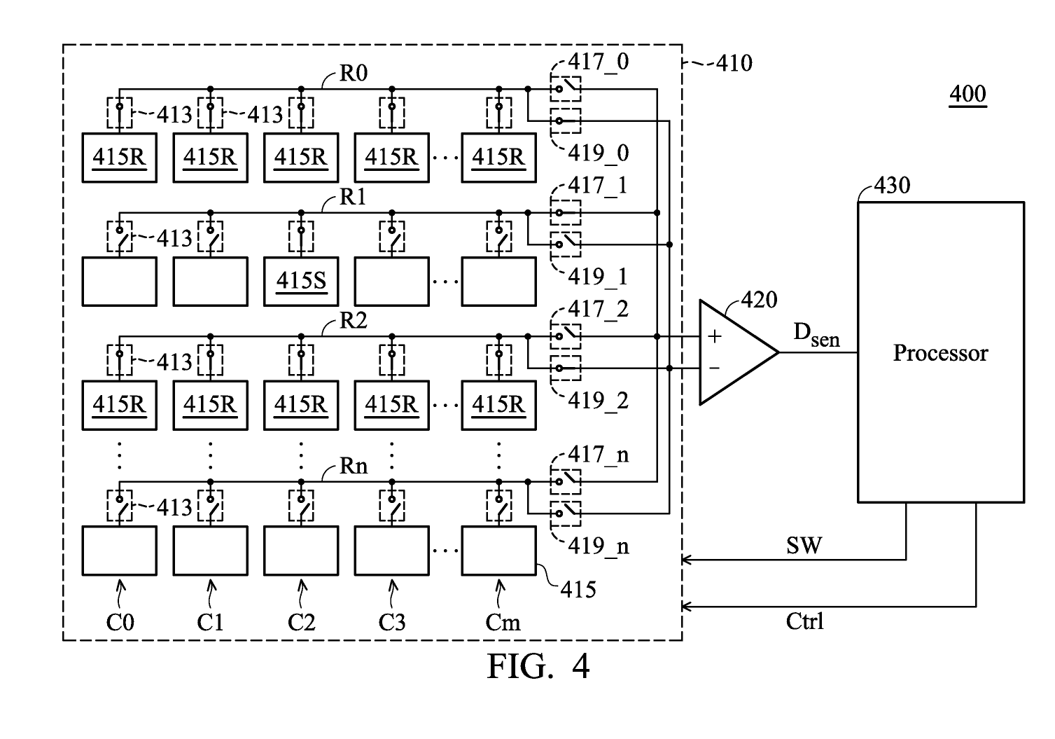

FIG. 4 shows a fingerprint sensor 400 according to another embodiment of the invention. The fingerprint sensor 400 comprises a sensing array 410, a differential amplifier 420 and a processor 430. The sensing array 410 comprises a plurality of sensing units 415, a plurality of switches 413, a plurality of switches 417_0-417_n and a plurality of switches 419_0-419_n. In the embodiment, each sensing unit 415 is coupled to the corresponding row line via the corresponding switch 413, wherein each switch 413 is controlled by the column line corresponding to the sensing unit. Furthermore, each row line is coupled to a non-inverting input terminal (positive input terminal) of the differential amplifier 420 via the corresponding switch 417, and is coupled to an inverting input terminal of the differential amplifier 420 via the corresponding switch 419. For example, the switch 417_0 is coupled between the row line R0 and the non-inverting input terminal of the differential amplifier 420, and the switch 419_0 is coupled between the row line R0 and the inverting input terminal of the differential amplifier 420. In FIG. 4, assuming that the target sensing unit 415S which is going to sense is located in an intersection of the row line R1 and the column line C2 in the sensing array 410, the processor 430 will provide a control signal Ctrl to the sensing array 410, so as to turn on the switch 413 corresponding to the target sensing unit 415S, and to turn off the other switches 413 in the row line R1. Furthermore, the processor 430 provides a control signal SW to the sensing array 410, so as to turn on the switch 417_1 and turn off the switch 419_1. Thus, the target sensing voltage Vₛₑₙ from the sensing electrode of the target sensing unit 415S is transmitted to the non-inverting input terminal of the differential amplifier 420. Simultaneously, the processor 430 provides the control signal Ctrl to turn on all of the switches 413 in the row line R0 and the row line R2, and provides the control signal SW to turn on the switches 419_0 and 419_2 and turn off the switches 417_0 and 417_2. Moreover, the processor 430 provides the control signal Ctrl to turn off all of the switches 413 in the row lines R3-Rn, and provides the control signal SW to turn off the switches 417_3-417-n and the switches 419_3-419-n. Thus, the reference sensing voltages V_{ref} of all of the reference sensing units 415R that are in the row line R0 and the row line R2 and are adjacent to the target sensing unit 415S, are transmitted to the inverting input terminal of the differential amplifier 420. Since the sensing electrodes of all of the reference sensing units 415R are coupled to the inverting input terminal of the differential amplifier 420, the sensing capacitors Cₛₑₙ of all of the reference sensing units 415R provide an equivalent average sensing voltage V_{avg} to the inverting input terminal of the differential amplifier 420 according to a voltage divided result. Thus, the differential amplifier 420 can remove a common mode noise between the average sensing voltage V_{avg} and the target sensing voltage Vₛₑₙ, i.e. the interference signals received by each sensing electrode can be removed. Therefore, the obtained sensing output Dₛₑₙ comprises the signal sensed by the sensing electrode of the target sensing unit 415S, and does not comprise the unwanted noise components.

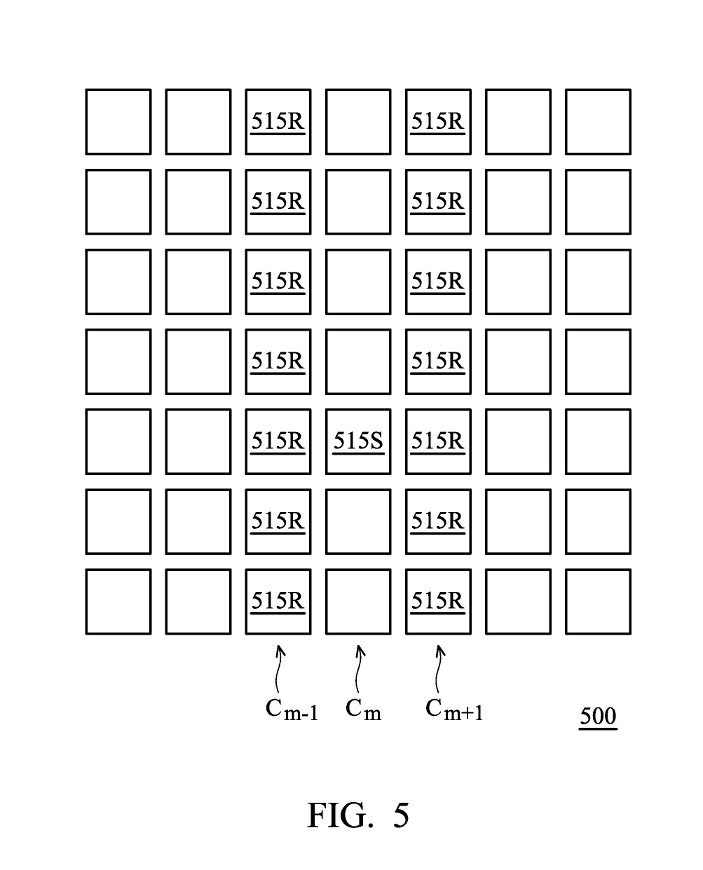

FIG. 5 shows a sensing array 500 for illustrating the relation among a target sensing unit 515S and a plurality of reference sensing units 515R according to an embodiment of the invention. In the embodiment, the target sensing unit 515S is arranged in a specific column line (e.g. Cₘ) of the sensing array 500, and the reference sensing units 515R are arranged in two neighboring column lines (e.g. the neighboring lines Cₘ₋₁ and Cₘ₊₁) adjacent to the specific column line. Since the reference sensing units 515R are adjacent to the target sensing unit 515S, the reference sensing units 515R and the target sensing unit 515S have similar sensing outputs for the same interference noise. Thus, the processor can obtain the actual sensing result according to the difference between the target sensing voltage Vₛₑₙ of the target sensing unit 515S and the reference average voltage V_{avg} of the reference sensing units 515R. It should be noted that the number of the reference sensing units 515R adjacent to the target sensing unit 515S and the number of the column lines where the reference sensing units 515R are disposed, are determined according to the actual application.

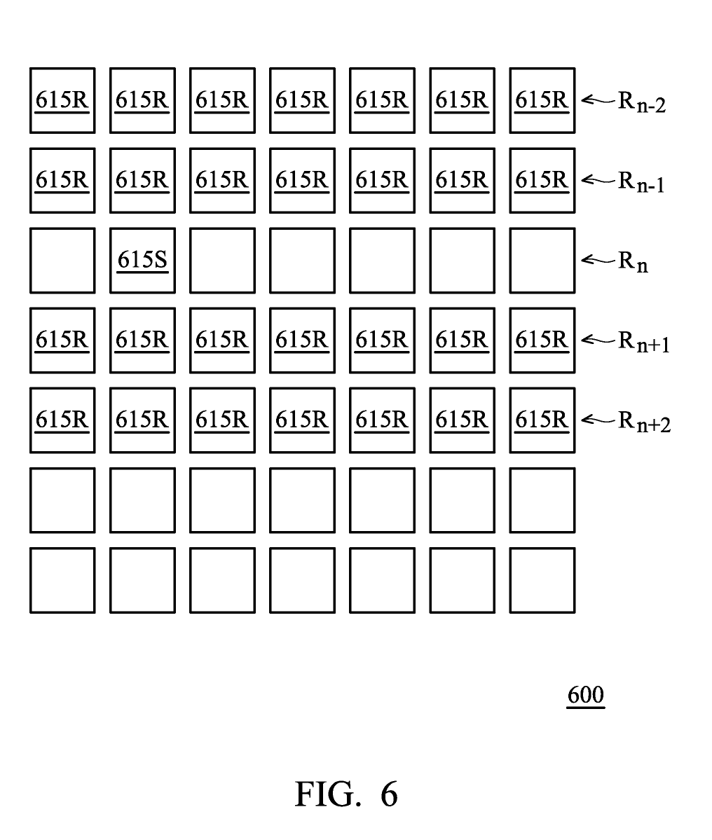

FIG. 6 shows a sensing array 600 for illustrating the relation among a target sensing unit 615S and a plurality of reference sensing units 615R according to another embodiment of the invention. In the embodiment, the target sensing unit 615S is arranged in the specific row line (e.g. Rₙ) of the sensing array 600, and the reference sensing units 615R are arranged in four neighboring row lines (e.g. Rₙ₋₂, Rₙ₋₁, Rₙ₊₁ and Rₙ₊₂) adjacent to the specific row line. As described above, since the reference sensing units 615R are adjacent to the target sensing unit 615S, the reference sensing units 615R and the target sensing unit 615S have similar sensing outputs for the same interference noise. Thus, the processor can obtain the actual sensing result according to the difference between the target sensing voltage Vₛₑₙ of the target sensing unit 615S and the reference average voltage V_{avg} of the reference sensing units 615R. It should be noted that the number of the reference sensing units 615R adjacent to the target sensing unit 615S and the number of the row lines where the reference sensing units 615R are disposed, are determined according to the actual application.

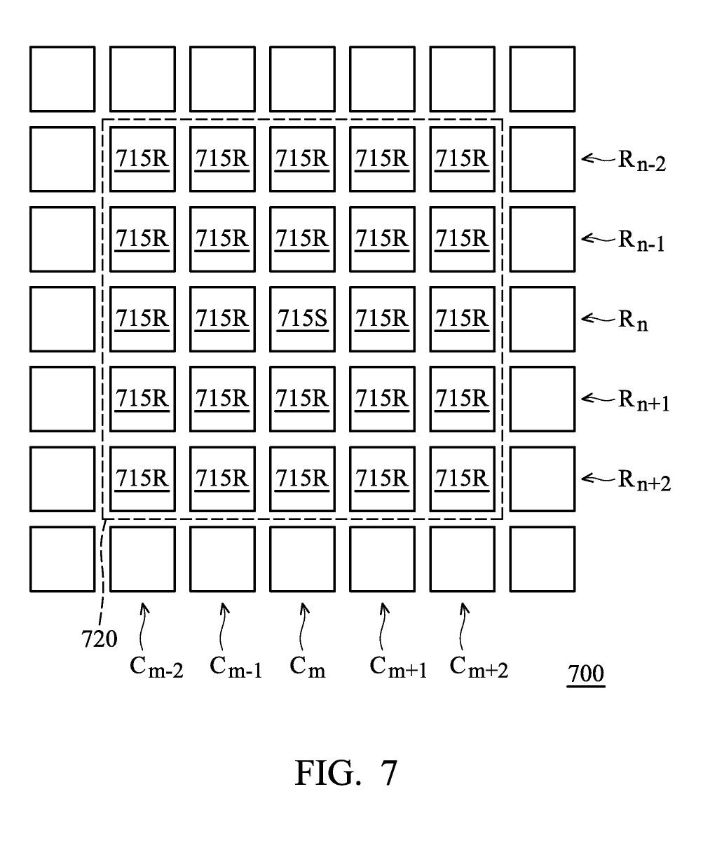

FIG. 7 shows a sensing array 700 for illustrating the relation among a target sensing unit 715S and a plurality of reference sensing units 715R according to another embodiment of the invention. In the embodiment, the target sensing unit 715S is arranged in the intersection of a specific row line and a specific column line (e.g. Rₙ and Cₘ) of the sensing array 700, and the reference sensing units 715R are arranged in a reference area 720 formed by a plurality of row lines and a plurality of column lines, wherein the target sensing unit 715S is arranged in the center of the reference area 720. In the embodiment, the reference area 720 is a rectangular area formed by the row line Rₙ₋₂ to the row line Rₙ₊₂ and the column line Cₘ₋₂ to the column line Cₘ₊₂. Specifically, in the reference area 720, the reference sensing units 715R are disposed around the target sensing unit 715S and surrounding the target sensing unit 715S. As described above, the location and range of the reference area 720 can be determined according to the actual application.

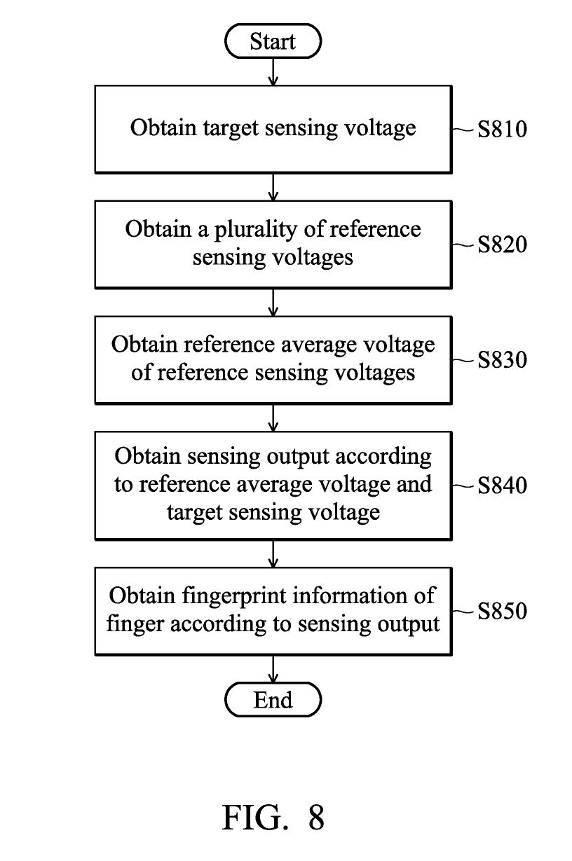

FIG. 8 shows a sensing method for a fingerprint sensor according to an embodiment of the invention, wherein the fingerprint sensor comprises a sensing array having a plurality of sensing units, a readout module and a processor. First, in step S810, the readout module obtains the target sensing voltage Vₛₑₙ of the target sensing unit in the sensing array. Next, in step S820, the readout module obtains the reference sensing voltages V_{ref} of a plurality of reference sensing units, wherein the reference sensing units are neighboring to the target sensing unit, i.e. located in a neighboring area surrounding the target sensing unit. Next, in step S830, the readout module obtains the reference average voltage V_{avg} of all the reference sensing voltages V_{ref}. Next, in step S840, the readout module obtains the sensing output Dₛₑₙ according to the reference average voltage V_{avg} and the target sensing voltage Vₛₑₙ. For example, the differential amplifier is used to remove the common mode noise between the target sensing voltage Vₛₑₙ and the reference average voltage V_{avg}, so as to obtain the sensing signal without interference. Next, in step S850, the processor obtains the fingerprint information of the finger according to the sensing output Dₛₑₙ.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fingerprint sensor for sensing fingerprint information of a finger, comprising:
a sensing array, comprising a plurality of sensing units disposed in a plurality of row lines and a plurality of column lines, wherein each of the sensing units comprises a sensing electrode;
an insulating surface disposed on the sensing array;
a readout module, providing a sensing output according to a first sensing voltage from the sensing array and an average voltage of a plurality of second sensing voltages from the sensing array; and
a processor, obtaining the fingerprint information of the finger according to the sensing output,
wherein the first sensing voltage is provided by the sensing electrode of a first sensing unit of the sensing units, and each of the second sensing voltages is provided by the sensing electrode of a second sensing unit of the sensing units,
wherein the second sensing units are neighboring to the first sensing unit.

2. The fingerprint sensor as claimed in claim 1, wherein the readout module comprises:
a differential amplifier, comprising:
a first input terminal coupled to the sensing electrode of the first sensing unit;
a second input terminal coupled to the sensing electrodes of the second sensing units; and
an output terminal, providing the sensing output,
wherein the sensing output represents a difference between the first sensing voltage and the average voltage of the second sensing voltages.

3. The fingerprint sensor as claimed in claim 1, wherein the first sensing unit is disposed in a specific column line of the sensing array, and the second sensing units are disposed in the other column lines neighboring to the specific column line in the sensing array.

4. The fingerprint sensor as claimed in claim 1, wherein the first sensing unit is disposed in a specific row line of the sensing array, and the second sensing units are disposed in the other row lines neighboring to the specific row line in the sensing array.

5. The fingerprint sensor as claimed in claim 1, wherein the second sensing units are disposed around and surrounding the first sensing unit.

6. A sensing method for a fingerprint sensor, wherein the fingerprint sensor comprises a sensing array having a plurality of sensing units disposed in a plurality of row lines and a plurality of column lines, the method comprising:
reading a first sensing voltage of a first sensing unit of the sensing units;
reading a plurality of second sensing voltages of a plurality of second sensing units of the sensing units;
generating a sensing output according to the first sensing voltage and an average voltage of the second sensing voltages, by a differential amplifier; and
generating fingerprint information of a finger according to the sensing output.

7. The sensing method as claimed in claim 6, wherein each of the sensing units comprises a sensing electrode, wherein the differential amplifier comprises:
a first input terminal coupled to the sensing electrode of the first sensing unit;
a second input terminal coupled to the sensing electrodes of the second sensing units; and
an output terminal, providing the sensing output,
wherein the sensing output represents a difference between the first sensing voltage and the average voltage of the second sensing voltages.

8. The sensing method as claimed in claim 6, wherein the first sensing unit is disposed in a specific column line of the sensing array, and the second sensing units are disposed in the other column lines neighboring to the specific column line in the sensing array.

9. The sensing method as claimed in claim 6, wherein the first sensing unit is disposed in a specific row line of the sensing array, and the second sensing units are disposed in the other row lines neighboring to the specific row line in the sensing array.

10. The sensing method as claimed in claim 6, wherein the second sensing units are disposed around and surrounding the first sensing unit.
